(19) United States
(12) Patent Application Publication
(10) Pub. No.: US 2008/0077924 A1
(43) Pub. Date: Mar. 27, 2008

(54) System and method for distributing and executing program code in a control unit network

(76) Inventor: Alfred Kuttenberger, Herrenberg (DE)

Correspondence Address: KENYON & KENYON LLP, ONE BROADWAY, NEW YORK, NY, 10004, US

(21) Appl. No.: 11/901,814

(22) Filed: Sep. 18, 2007

(30) Foreign Application Priority Data
Sep. 25, 2006 (DE) 102006045153.8

(51) Int. Cl. G06F 9/46

(52) U.S. Cl. 718/100

(57) ABSTRACT

A system and a method for distributing and executing program code in a control unit network, in which at least one of the units is able to detect a defect in its hardware and is able to transmit its code to at least one other control unit in the network, the transmitted code being executable on the target control unit.

### BACKGROUND INFORMATION

Up to now, control units have been installed, for instance, in motor vehicles which are designed corresponding to particularly predefined and limited functions. In normal operation, these units run only under partial load. However, many of them are dimensioned so that they could manage higher (even peak) loads. Moreover, many of these units are connected to one another via a network, for the exchange of data. In spite of that, such an entire system can become unusable if one of the units fails, for instance, because of a hardware defect.

A system for controlling/regulating the operating sequences in a motor vehicle is described in German Patent No. DE 100 27 006. It has a central memory in which all programs necessary for this are stored. At the start of the system, the control units load the required programs into their working memories via memory accesses. This permits a central management and modification of the individual functional units of the vehicle, to be sure, but it does not protect from their potential failure.

### SUMMARY OF THE INVENTION

It is an object of the present invention to provide a system and a method for distributing and executing program code in a control unit network, which has an increased operational security, that is simple to implement and is cost-effective.

This object is attained by a system according to the present invention, in which at least one of the control units is able to detect a defect in its hardware and can transmit its code to at least one other control unit in the network, the transmitted code being executable on the target control unit.

An important point of the system according to the present invention is that common resources of the network are used to compensate for the failure of individual units. Programs of the source units, in this context, can also be distributed to a plurality of different target units. A large failure tolerance of the system is created thereby, for hardware-conditioned component failures, which further ensures the functionality of the system. Since, in addition, no redundant memory portions have to be kept available, the costs of the system can be reduced.

It is provided in one specific embodiment that the source control unit has a great relevance to safety, compared to the other control units in the network. Thus, in particular, the ECU (electronic control unit) functions for antilock brake systems and stability systems, but also for passenger restraint systems (air bag, seat belt tensioners) are protected, in order to continue to ensure their functioning in every case. The operational safety of a vehicle is substantially increased by this.

An advantage is also created if the source control unit is designed to transmit a reduced program to the target unit. The reduced program, in this instance, can be limited to its actual safety-critical functions, which requires fewer free resources on the target unit. Because of this, the programs that are already running on the target unit are not impaired, or rather, even slight resources can still be used.

An additional advantage is created if the target control unit is equipped to shut down programs and/or program parts having comparatively low safety relevance. The shutting down can be with regard both to programs that are already running on the target unit and/or programs and or program portions transmitted to it, whereas programs having high safety relevance remain activated or are activated. On the target unit, resources are released thereby, or fewer additional resources are required, so that as many safety-relevant functions can be carried out as possible.

The object mentioned above is also attained by a method according to the present invention, in which, when a control unit detects a hardware defect, its code is transmitted to at least one other control unit in the network, and the transmitted code is executed on the target control unit.

One substantial point of the method according to the present invention is that it is constructed particularly simply, and is thus safe. Since it can also be added on to the usual communications protocols in vehicle electrical systems, such as CAN (controller area network) bus, it is also easy to implement and therefore cost-effective.

It is provided in one advantageous specific embodiment that it is first determined whether the target control unit has free resources for executing the program code, and if this is the case, these free resources are reserved for executing the transmitted code. Because of this, one does not have to establish a communications partner right from the beginning, for every failure-protected control unit. To the contrary, because of the determination of free resources, a dynamic distribution of programs or program portions can be achieved, to control units which will have suitable resources when needed.

An advantage is created, in addition, if a program that is reduced in comparison to its full functional volume is transmitted by the source control unit to the target control unit. This avoids a particularly great load of the target unit, or rather, even slight resources can still be used, without having to limit safety-relevant core functions of the program.

One further advantage is created if programs and/or program portions having comparatively low safety relevance are shut down on the target control unit. That is how the target control unit can be utilized for the concentrated execution of functions of the highest priority.

### BRIEF DESCRIPTION OF THE DRAWINGS

FIG. 1a shows a schematic illustration of two intact control units, which are connected to each other via a network.

FIG. 1b shows the configuration of FIG. 1a in which the function of a defective control unit is portrayed by the other control unit.

### DETAILED DESCRIPTION

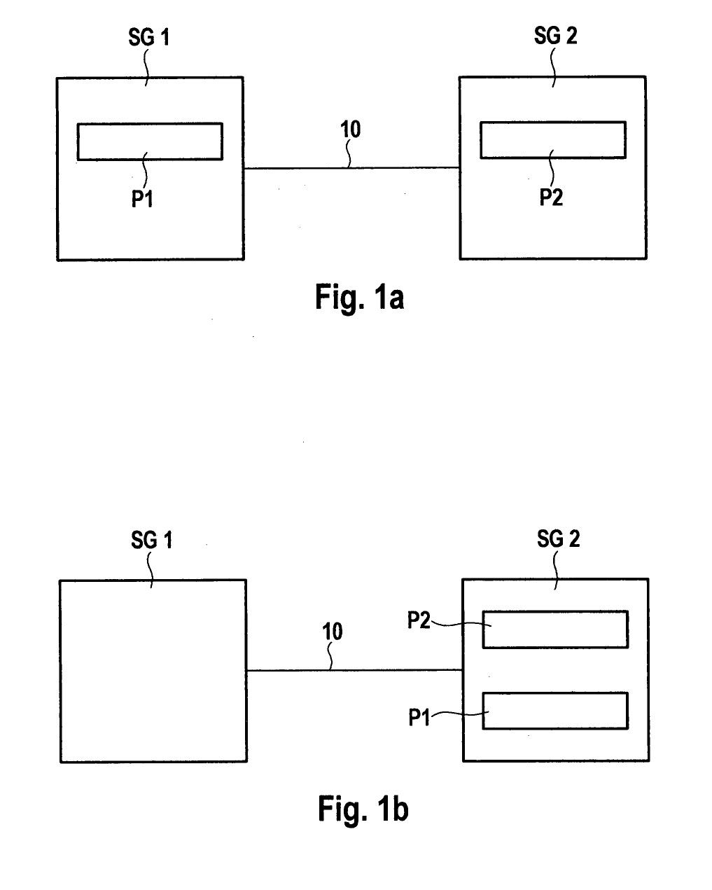

FIG. 1a shows a schematic representation of two intact control units SG1 and SG2 that are connected to each other via a network 10. Network 10 is designed as a data bus and a program bus via which control units SG1 and SG2 are able to exchange data portions and program software portions. Control unit SG1, for instance, is responsible for the operation of an antilock system and unit SG2 for engine control.

The functioning of these applications is shown by a program code P1 and P2, which are executed on units SG1 and SG2, respectively. Now, if a hardware defect is detected in control unit SG1, calculator resources in unit SG2 that are still free are reserved, program code P1 of unit SG1 is transmitted via network 10 and brought to execution on unit SG2.

FIG. 1b shows the configuration of FIG. 1a, in which the function of a defective control unit SG1 is portrayed by the other control unit SG2. Program code P1 of unit SG1 was transmitted to unit SG2, in this context, and was brought to execution next to code P2. In principle, even only reduced programs can be transmitted by control unit SG1, in this context, in order not to impair the programs on unit SG2. Furthermore, programs or program portions which have a comparatively low priority, can also be shut down on target control unit SG2, and the programs having a high safety relevance can be activated.

Because of that, even when there are hardware defects in the especially safety-relevant control unit SG1, a residual function of the antilock system can be represented, which considerably increases its failure tolerance, and therewith its operating safety. Because of shifting code P1 from defective unit SG1 to intact unit SG2, no redundant memory portions have to be held in reserve, whereby costs can be reduced. The method according to the present invention builds upon known communications mechanisms in networks and is simple to implement, easy to maintain and cost-effective.

What is claimed is:

1. A system for distributing and executing program code in a control unit network, comprising:
a source control unit and a target control unit, the source control unit being adapted to detect a defect in its hardware and to transmit its code to the target control unit in the network, the target control unit being adapted to execute the transmitted code.

2. The system according to claim 1, wherein the source control unit has a high safety relevance compared to the target control unit in the network.

3. The system according to claim 1, wherein the source control unit transmits a reduced program to the target control unit.

4. The system according to claim 1, wherein the target control unit shuts down at least one of (a) programs and (b) program portions having comparatively low safety relevance.

5. A method for distributing and executing program code in a control unit network, the method comprising:
if a hardware defect is detected in a source control unit, transmitting its code to a target control unit in the network; and
executing the transmitted code in the target control unit.

6. The method according to claim 5, further comprising:
determining whether the target control unit has free resources for executing the program code; and
if this is the case, reserving the free resources for executing the transmitted code.

7. The method according to claim 5, further comprising transmitting a program reduced in comparison to its full functional scope from the source control unit to the target control unit.

8. The method according to claim 5, further comprising shutting down at least one of (a) programs and (b) program portions having comparatively low safety relevance on the target control unit.
